(19) United States
(12) Patent Application Publication
(10) Pub. No.: US 2004/0000871 A1
(43) Pub. Date: Jan. 1, 2004

(54) Plasma display panel

(75) Inventors: Hirofumi Higashi, Yamanashi-ken (JP); Shingo Ogane, Yamanashi-ken (JP)

Correspondence Address: ARENT FOX KINTNER PLOTKIN & KAHN, PLLC, Suite 600, 1050 Connecticut Avenue, N.W., Washington, DC, 20036-5339, US

(73) Assignees: PIONEER CORPORATION; PIONEER DISPLAY PRODUCTS

(21) Appl. No.: 10/459,433

(22) Filed: Jun. 12, 2003

(30) Foreign Application Priority Data
Jun. 28, 2002 (JP) 2002-189891

(51) Int. Cl. H01J 17/49

(52) U.S. Cl. 313/582

(57) ABSTRACT

When viewed from the surface of a front substrate, a light absorption layer is formed at least in part on the back surface of the front substrate in alignment with a part between two back-to-back bus electrodes and of the respective row electrode pairs adjacent to each other in the row direction and with a part ranging from the part to the vicinity of a side edge of each of the bus electrodes and connected to the corresponding transparent electrodes. A light reflection layer is formed on the back surface of the light absorption layer.

### BACKGROUND OF THE INVENTION

1. Field of the Invention

This invention relates to the cell structure of a plasma display panel.

The present application claims priority from Japanese Application No. 2002-189891, the disclosure of which is incorporated herein by reference.

2. Description of the Related Art

In recent years, plasma display panels have become commonplace as a display panel for use in a large-sized flat color-screen display.

FIG. 1 is a schematic front view illustrating a conventional cell structure of the plasma display panel. FIG. 2 is a sectional view taken along the V-V line in FIG. 1, and FIG. 3 is a sectional view taken along the W-W line in FIG. 1.

In FIGS. 1 to 3, a front glass substrate 1 serving as the display screen of the plasma display panel has a back surface on which a plurality of row electrode pairs (X1, Y1), a dielectric layer 2 covering the row electrode pairs (X1, Y1), and an MgO-made protective layer 3 covering the back surface of the dielectric layer 2 are formed in this order.

Each of the row electrodes X1, Y1 in each row electrode pair includes a transparent electrode X1a, Y1a which is formed of a transparent conductive film made of ITO (Indium Tin Oxide) or the like and having a large width, and a bus electrode X1b, Y1b which is formed of a metal film of a small width assisting the conductivity of the transparent electrode X1a, Y1a.

The row electrodes X1 and Y1 are arranged in alternate positions in the column direction such that the row electrodes X1 and Y1 in each row electrode pair (X1, Y1) face each other with a discharge gap g1 in between, and therefore each row electrode pair (X1, Y1) forms a display line L in matrix display.

The front glass substrate 1 is opposite a back glass substrate 4 with a discharge space S1 filled with a discharge gas in between. On the opposing surface of the back glass substrate 4 are a plurality of column electrodes D1 regularly arranged and each extending in a direction at right angles to the row electrode pairs (X1, Y1); partition walls 5 each extending in a belt shape and in parallel between the adjacent column electrodes D1; and red-, green-, and blue-colored phosphor layers 6 each formed in such a way as to cover the side faces of the partition walls 5 and the column electrode D1.

In each display line L, the partition walls 5 define discharge cells C1, respectively forming unit light-emitting areas, at intersections of the column electrodes D1 and the row electrode pair (X1, Y1) within the discharge space S1.

The surface-discharge-type AC plasma display panel displays images as follows:

First, an addressing operation is performed to selectively cause an opposite discharge between the row electrode pair (X1, Y1) and the column electrode D1 in each discharge cell C1 for distribution of the lighted cells (discharge cells having wall charges generated on the dielectric layer 2) and the non-lighted cells (discharge cells having no wall charges generated on the dielectric layer 2) over the panel surface in accordance with the image to be displayed.

Subsequent to the addressing operation, simultaneously in all the display lines L, a discharge-sustaining pulse is applied alternately to the row electrodes in each row electrode pair (X1, Y1) to trigger a surface discharge in each lighted cell with every application of the discharge-sustaining pulse.

Ultraviolet light thus generated by the surface discharge in each lighted cell excites each of the red-, green-, and blue-colored phosphor layers 6 formed in the individual discharge cells C1 to emit visible light for the generation of the image. The conventional surface-discharge-type AC plasma display panels designed as described above have the disadvantage that the reflection of ambient light incident upon the area between the back-to-back bus electrodes X1b and Y1b which is a non-display line may cause a decrease in contrast of the image formed on the panel surface.

Under the circumstances, the present applicant has proposed a plasma display panel having a black- or dark-colored, belt-shaped light absorption layer 7 extending in the row direction in each non-display line existing between the back-to-back bus electrodes X1b and Y1b on the dielectric layer 2 as illustrated in FIGS. 1 and 3 in order to prevent the reflection of ambient light in the non-display line for improvement in image contrast.

However, the black-, or dark-colored light absorption layer 7 formed in each non-display line on the panel may absorb the amount of light travelling toward the light absorption layer 7 out of the total light emitted from the phosphor layer 6, in addition to the ambient light. This introduces another disadvantage of a decrease of the amount in light available for the generation of an image.

### SUMMARY OF THE INVENTION

The present invention has been made to solve the disadvantages.

It is therefore an object of the present invention to provide plasma display panels capable of improving image contrast and preventing a decrease of the amount of light available for the generation of an image for enhancement in efficiency in the use of light emission.

To attain the above object, a plasma display panel according to an aspect of the present invention includes: a front substrate and a back substrate which are opposite to each other with a discharge space in between; a plurality of row electrode pairs which are regularly arranged in a column direction on a back surface of the front substrate and each extend in the row direction to form a display line; a dielectric layer which is formed on the back surface of the front substrate to cover the row electrode pairs; and a plurality of column electrodes which are regularly arranged in the row direction on a surface of the back substrate opposite the front substrate and each extend in the column direction to constitute unit light-emitting areas at intersections with the row electrode pairs in the discharge space, in which one row electrode in each row electrode pair is constituted of transparent electrodes each having an end facing that of the corresponding transparent electrode of the other row electrode in the row electrode pair with a required discharge gap in between, and a bus electrode extending in the row direction and connected to an reverse end of each of the transparent electrodes from the end thereof facing the discharge gap. Such a plasma display panel has a feature of including: a light absorption layer which is formed, when viewed from the surface of the front substrate, at least in part on the back surface of the front substrate in alignment with a part between two back-to-back bus electrodes of the respective row electrode pairs adjacent to each other in the row direction, and also with a part ranging from the part to a vicinity of a side edge of the bus electrode connected to each transparent electrode; and a light reflection layer which is formed on the back surface of the light absorption layer.

These and other objects and features of the present invention will become more apparent from the following detailed description with reference to the accompanying drawings.

### BRIEF DESCRIPTION OF THE DRAWINGS

FIG. 1 is a front view illustrating a conventional plasma display panel.

FIG. 2 is a sectional view taken along the V-V line of FIG. 1.

FIG. 3 is a sectional view taken along the W-W line of FIG. 1.

FIG. 4 is a schematic front view illustrating a first embodiment according to the present invention.

FIG. 5 is a sectional view taken along the V1-V1 line of FIG. 4.

FIG. 6 is a sectional view taken along the V2-V2 line of FIG. 4.

FIG. 7 is a sectional view taken along the W1-W1 line of FIG. 4.

FIG. 8 is a sectional view taken along the W2-W2 line of FIG. 4. FIG. 9 is a sectional view for diagrammatically illustrating the state of the light reflected by a light reflection layer in the first embodiment.

FIG. 10 is a schematic front view illustrating a second embodiment according to the present invention.

FIG. 11 is a sectional view taken along the V3-V3 line of FIG. 10.

FIG. 12 is a sectional view taken along the V4-V4 line of FIG. 10.

FIG. 13 is a sectional view taken along the W3-W3 line of FIG. 10.

FIG. 14 is a sectional view taken along the W4-W4 line of FIG. 10.

FIG. 15 is a plan view partially illustrating the shape of a light absorption layer in the second embodiment.

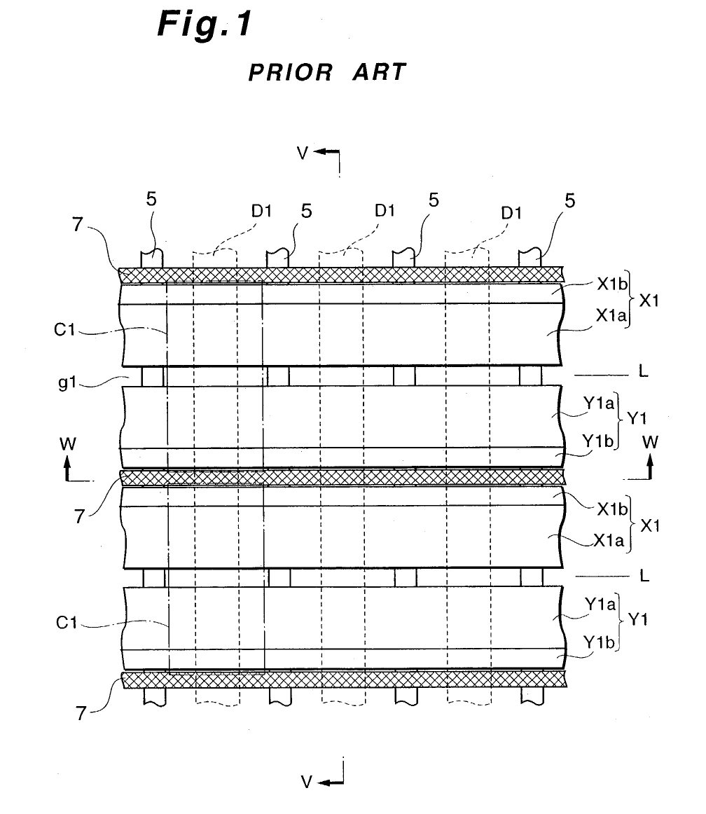

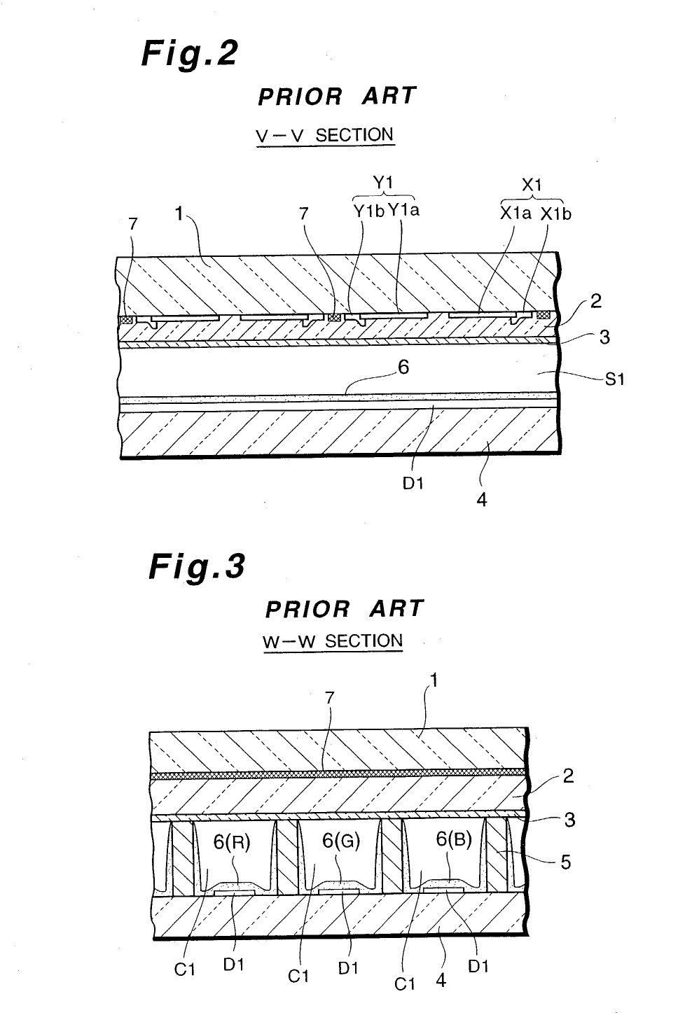

### DETAILED DESCRIPTION OF THE PREFERRED EMBODIMENTS

Preferred embodiments according to the present invention will be described hereinafter in detail with reference to the accompanying drawings.

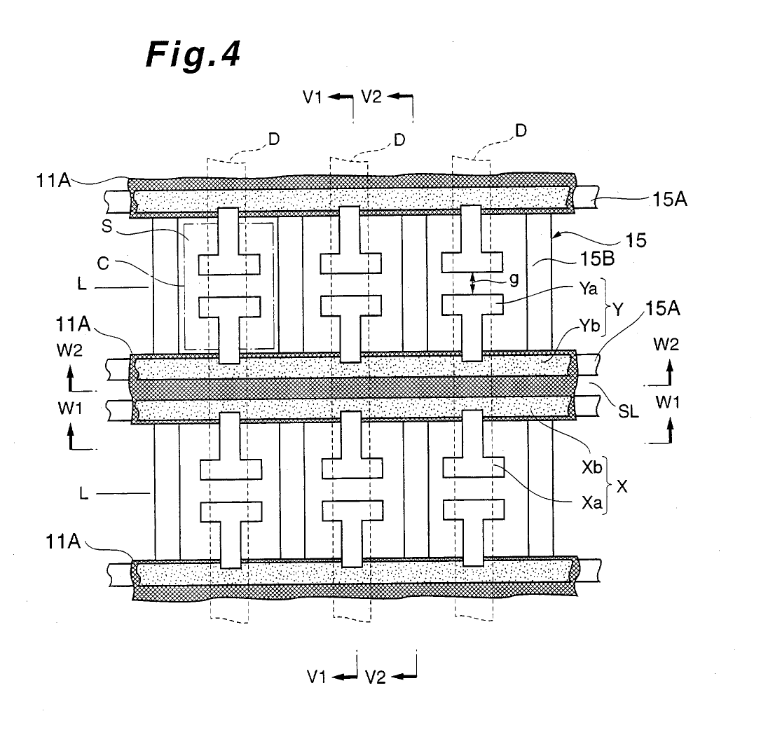

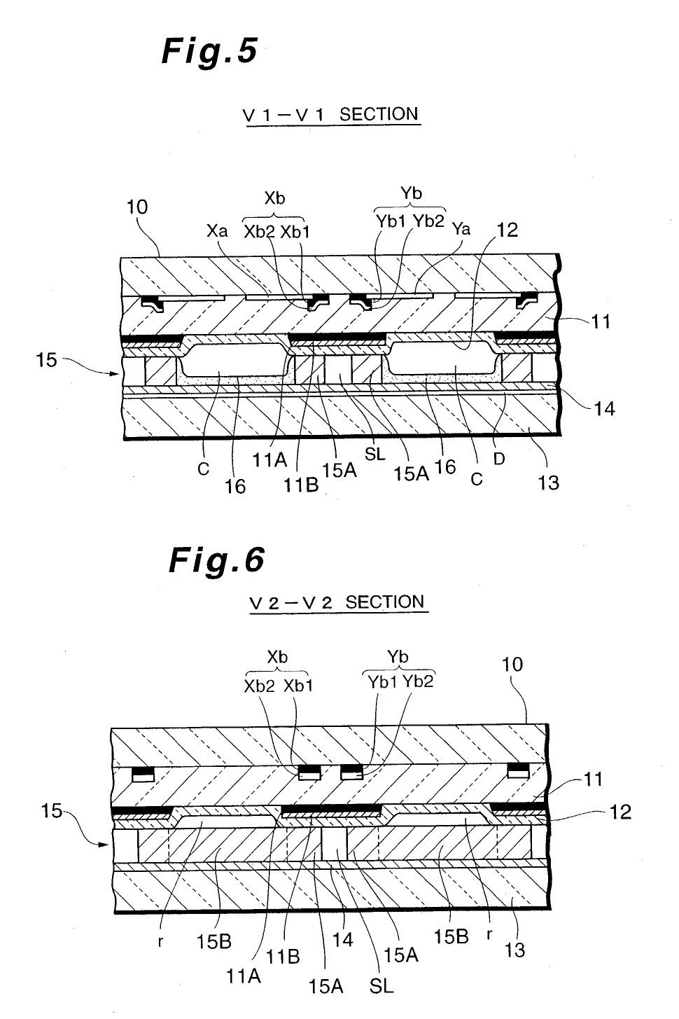

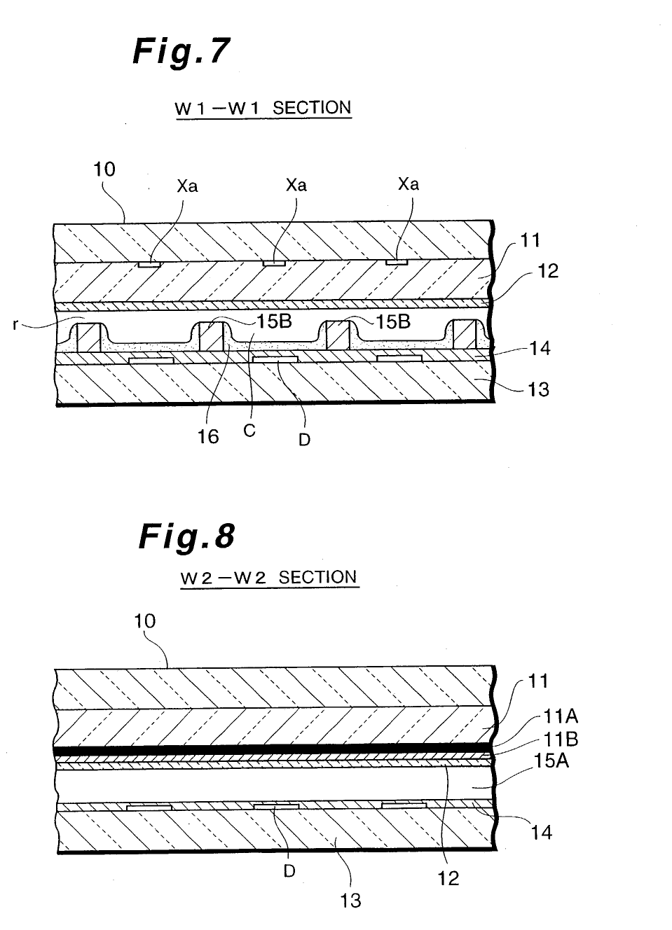

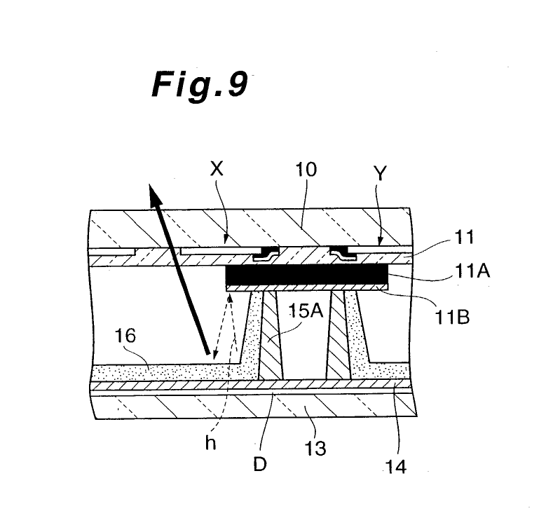

FIGS. 4 to 8 illustrate a first embodiment according to the present invention: FIG. 4 is a schematic front view illustrating the configuration of a plasma display panel (hereinafter referred to as “PDP”); FIG. 5 a sectional view taken along the V1-V1 line of FIG. 4; FIG. 6 a sectional view taken along the V2-V2 line of FIG. 4; FIG. 7 a sectional view taken along the W1-W1 line of FIG. 4; and FIG. 8 a sectional view taken along the W2-W2 line of FIG. 4.

In FIGS. 4 to 8, a front glass substrate 10 serving as a display screen has a back surface on which a plurality of row electrode pairs (X, Y) are arranged in parallel and each extend in the row direction of the front glass substrate 10 (i.e. the right-left direction in FIG. 4).

The row electrode X is constituted of transparent electrodes Xa each formed of a T-shaped transparent conductive film made of ITO or the like, and a bus electrode Xb formed of a metal film extending in the row direction of the front glass substrate 10 and connected to the narrowed proximal ends (i.e. the foot of the T shape) of the transparent electrodes Xa.

Likewise, the row electrode Y is constituted of transparent electrodes Ya each formed of a T-shaped transparent conductive film made of ITO or the like, and a bus electrode Yb formed of a metal film extending in the row direction of the front glass substrate 10 and connected to the narrowed proximal ends (i.e. the foot of the T shape) of the transparent electrodes Ya.

The row electrodes X and Y are regularly arranged in alternate positions in the column direction of the front glass substrate 10 (i.e. the vertical direction in FIG. 4). The opposing transparent electrodes Xa and Ya which are regularly arranged along the corresponding bus electrodes Xb and Yb in each row electrode pair (X, Y) extend toward each other so that the tops of the widened distal ends (i.e. the head of the T shape) of the respective transparent electrodes Xa and Ya are opposite each other with a discharge gap g set at a required distance in between.

Each of the bus electrodes Xb and Yb is formed in a double layer structure consisting of a black conductive layer Xb1, Yb1 positioned close to the display screen and a main conductive layer Xb2, Yb2 positioned behind this.

In addition, a dielectric layer 11 is formed on the back surface of the front glass substrate 10 so as to cover the row electrode pairs (X, Y).

On the back surface of the dielectric layer 11, additional belt-shaped dielectric layers 11A protrude backward from the dielectric layer 11, and each extend in the row direction opposite an area between the back-to-back bus electrodes Xb and Yb of the respective row electrode pairs (X, Y) adjacent to each other, and also opposite the back-to-back bus electrodes Xb and Yb concerned, and further opposite areas respectively continuing for a required distance from the bus electrodes Xb and Yb concerned in the directions of the proximal ends of the respective transparent electrodes Xa and Ya.

The additional dielectric layer 11A is formed of black- or dark-colored dielectric materials to constitute a light absorption layer.

A light reflection layer 11B is further formed on the back surface of the additional dielectric layer (light absorption layer) 11A.

An MgO protective layer 12 is formed on the back surfaces of the dielectric layer 11 and the additional dielectric layers 11A and light reflection layers 11B.

In turn, a back glass substrate 13 placed in parallel to the front glass substrate 10 has a surface, facing toward the display screen, on which column electrodes D are arranged in parallel to each other at predetermined intervals so that each extends in a direction at right angles to the row electrode pairs (X, Y) (i.e. the column direction) opposite the paired transparent electrodes Xa and Ya of each row electrode pair (X, Y).

The column electrodes D formed on the surface of the back glass substrate 13 facing toward the display screen are covered with a white-colored dielectric layer 14, and partition walls 15 are formed on the dielectric layer 14.

Each of the partition walls 15 is shaped in a ladder pattern by a pair of transverse walls 15A respectively extending in the row direction in positions opposite the corresponding bus electrodes Xb and Yb of the row electrodes X and Y in each row electrode pair (X, Y), and vertical walls 15B each extending in the column direction between the paired transverse walls 15A and at a midpoint between the adjacent column electrodes D arranged in parallel.

The adjacent ladder-patterned partition walls 15 are arranged in parallel to each other in the column direction with an interstice SL in between. The interstice SL is formed opposite an area between the back-to-back bus electrodes Xb and Yb of the respective row electrode pairs (X, Y) adjacent to each other. The partition walls 15 partition the discharge space S defined between the front glass substrate 10 and the back glass substrate 13 into areas each opposite to the paired transparent electrodes Xa and Ya in each row electrode pair (X, Y) to form quadrangular discharge cells C.

The face of the vertical wall 15B of the partition wall 15 facing toward the display screen is out of contact with the protective layer 12 (see FIGS. 6 and 7) to form a clearance r between them. The face of the transverse wall 15A facing toward the display screen is in contact with a portion of the protective layer 12 covering the additional dielectric layer 11A and light reflection layer 11B (see FIGS. 5, 6 and 8) to close off the adjacent discharge cells C from each other in the column direction.

Inside each of the discharge cells C, a phosphor layer 16 covers five faces, namely, the face of the dielectric layer 14 and the four side faces of the transverse walls 15A and the vertical walls 15B of the partition wall 15. One of the three colors, red, green and blue, is applied in turn to the individual phosphor layer 16 so that the red, green and blue colors in the individual discharge cells C are arranged in order in the row direction.

The discharge cells C are filled with a discharge gas.

In the foregoing PDP, each row electrode pair (X, Y) constitutes a display line L on the matrix display screen.

The PDP display images in the same way as conventional PDPs.

First, in an addressing discharge period, a discharge is selectively generated between the row electrode Y in the row electrode pair (X, Y) and the column electrode D in each discharge cell C for distribution of the lighted cells (discharge cells having wall charges generated on the dielectric layer 11) and the non-lighted cells (discharge cells having no wall charges generated on the dielectric layer 11) in all the display lines L over the panel surface in accordance with an image to be displayed.

In a sustaining discharge period subsequent to the addressing discharge period, simultaneously in all the display lines L, a discharge-sustaining pulse is applied alternately to the row electrodes X, Y of the row electrode pair (X, Y) to trigger a surface discharge between the row electrodes X and Y across the discharge gap g in each lighted cell with every application of the discharge-sustaining pulse.

Ultraviolet light thus generated by the surface discharge in each lighted cell excites each of the red-, green-, and blue-colored phosphor layers 16 formed in the individual discharge cells C to emit visible light for the generation of the image to be displayed.

At this point, as diagrammatically illustrated in FIG. 9, a light h travelling toward the additional dielectric layer 11A out of the total light emitted from the phosphor layer 16 travels the route of being reflected by the light reflection layer 11B formed on the back surface of the additional dielectric layer 11A concerned, then reflected by the phosphor layer 16, and the like, and then finally being outputted from the inside of the discharge cell C toward the outside of the display screen of the front glass substrate 10.

The amount of light out of the total light emitted from the phosphor layer 16 which is conventionally absorbed by a light absorption layer provided in the non-display line on the panel, is thus reflected by the light reflection layer 11B to contribute to the formation of the image, resulting in an enhancement in the efficiency in the use of the light emitted from the phosphor layer 16.

Further, ambient light incident upon the non-display line of the panel is absorbed by the black conductive layers Xb1 and Yb1 constituting the respective bus electrodes Xb and Yb, and the additional dielectric layer 11A serving as the light absorption layer. In consequence, image contrast is prevented from being lowered by the reflection of the ambient light.

In the first embodiment, the formation of the black- or dark-colored additional dielectric layer 11A opposite the area extending beyond both of the back-to-back bus electrodes Xb and Yb toward the corresponding proximal ends of the transparent electrodes Xa and Ya, is aimed at three points of: limiting the impossibility of harnessing the light emission generated by means of the discharge as light for displaying the image around the bus electrodes Xb and Yb; absorption of ambient light incident from the front glass substrate 10 onto the area around the proximal ends of the transparent electrodes Xa and Ya in which the light emission generated by means of the discharge becomes weak because the proximal ends are located at a distance from the gap g; and prevention of the reflection of ambient light from the transverse wall 15A on which no light absorption layer is formed. The achievement in those three points allows a further improvement in image contrast.

Even though the additional dielectric layer 11A is formed opposite the area extending beyond the bus electrodes Xb and Yb toward the corresponding proximal ends of the transparent electrodes Xa and Ya, the light emitted from the phosphor layer 16 and travelling toward the additional dielectric layer 11A is not absorbed by the additional dielectric layer 11A because of the light reflection layer 11B formed on the back surface of the additional dielectric layer 11A, and so be available for forming the image.

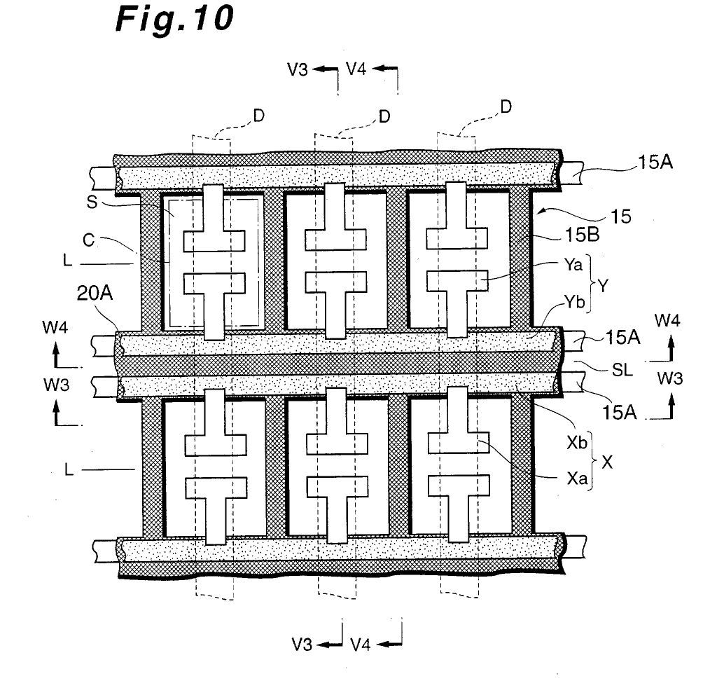

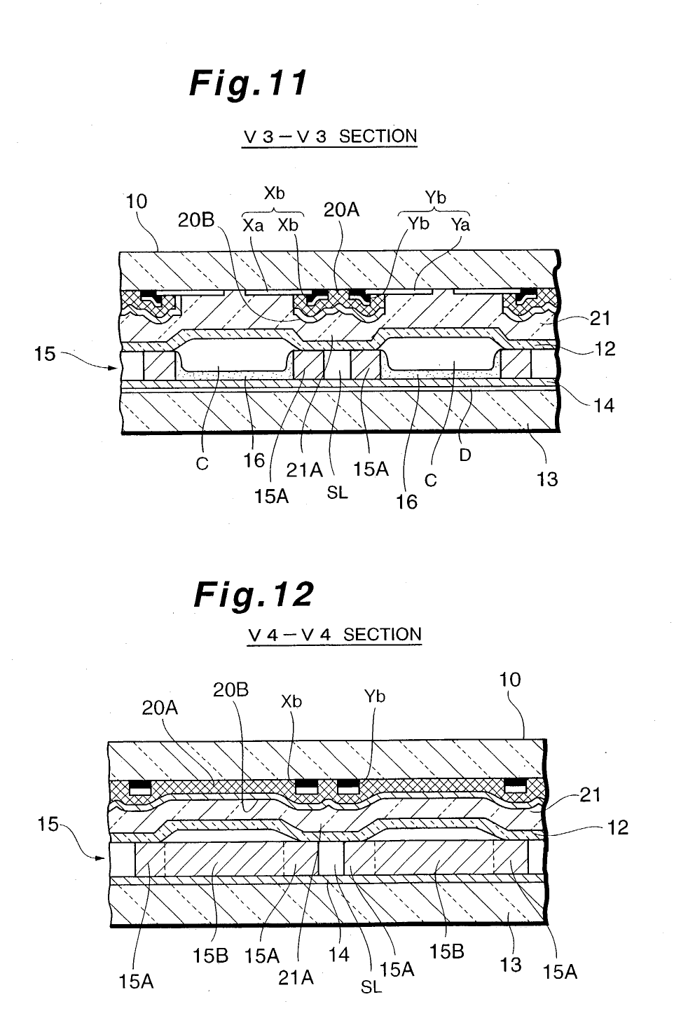

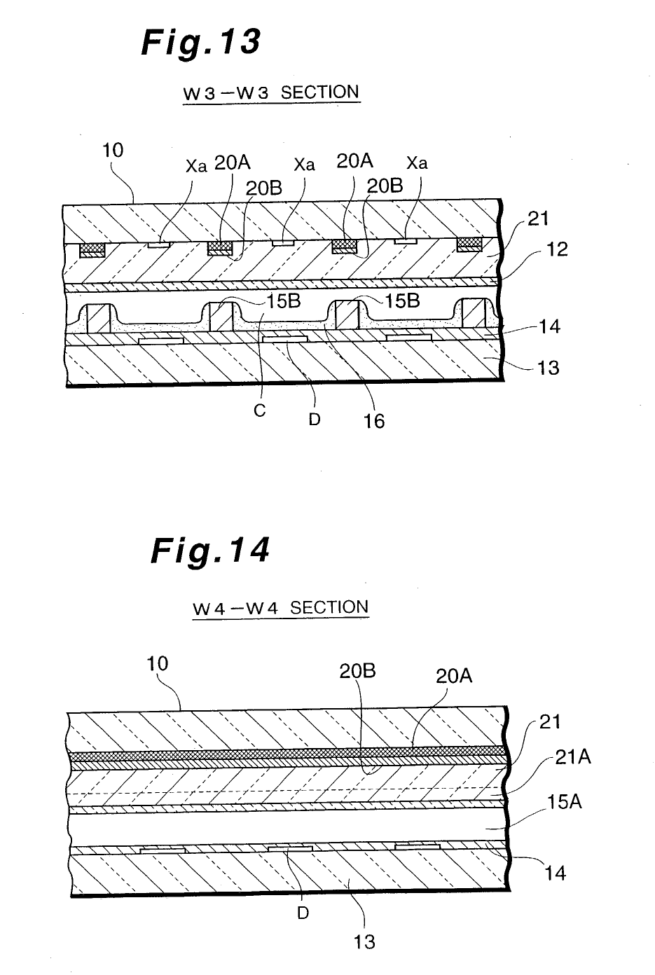

FIGS. 10 to 14 illustrate a second embodiment according to the present invention.

In the second embodiment, a black- or dark-colored light absorption layer 20A is formed in such a manner as to cover: an area between the back-to-back bus electrodes Xb and Yb of the respective row electrode pairs (X, Y) adjacent to each other on the back surface of the front glass substrate 10; the back-to-back bus electrodes Xb and Yb concerned; and areas respectively continuing for a required distance from the bus electrodes Xb and Yb concerned in the directions of the proximal ends of the respective transparent electrodes Xa and Ya, and also cover an area opposite each vertical wall 15B of the partition wall 15.

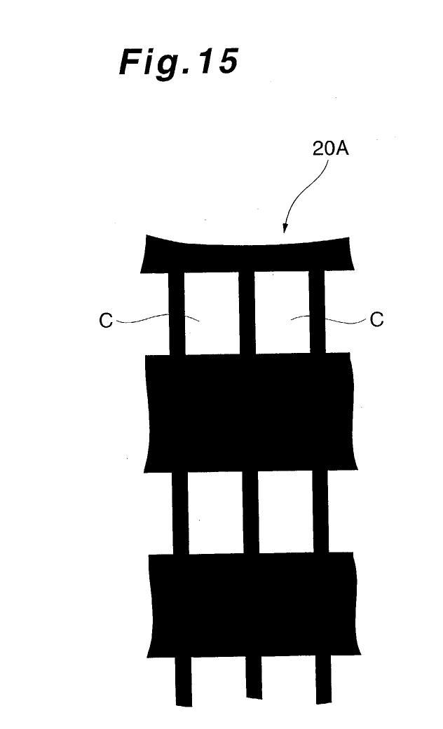

Accordingly, the light absorption layer 20A has a matrix-patterned plane shape having a quadrangular opening only in the area opposite each discharge cell C when viewed from the display screen of the front glass substrate 10 as illustrated in FIG. 15.

A light reflection layer 20B is formed so as to cover the back surface of the light absorption layer 20A.

A dielectric layer 21 is further formed on the back surface of the front glass substrate 10 in such a manner as to cover the row electrode pairs (X, Y) and the light absorption layer 20A and light reflection layer 20B. In turn, additional belt-shaped dielectric layers 21A formed of the same transparent dielectric materials as that of the dielectric layer 21, protrude backward from the back surface of the dielectric layer 21, and each extends in the row direction opposite an area between the back-to-back bus electrodes Xb and Yb of the respective row electrode pairs (X, Y) adjacent to each other, and also opposite the back-to-back bus electrodes Xb and Yb concerned, and further opposite areas respectively continuing for a required distance from the bus electrodes Xb and Yb concerned in the directions of the proximal ends of the respective transparent electrodes Xa and Ya.

Other configurations in the second embodiment are approximately similar to those of the PDP in the first embodiment, and are designated by the same reference numerals.

In the second embodiment, as in the case of the first embodiment, the light absorption layer 20A absorbs ambient light incident upon the non-display line on the panel to prevent the reflection of the ambient light for improvement in contrast in an image to be generated. Further, the light reflection layer 20B formed on the back surface of the light absorption layer 20A reflects light emitted from the phosphor layer 16 and travelling toward the non-display line on the panel to make use of the light for forming the image. This allows an enhancement in the efficiency in the use of the light emitted from the phosphor layer 16.

Further, the second embodiment has the light absorption layer 20A formed also in the area opposite each vertical wall 15B of the partition wall 15. With this light absorption layer 20A, the reflection of the ambient light incident upon the area is prevented so that image contrast is further improved. In addition, the light reflection layer 20B reflects the light emitted from the phosphor layer 16 toward the area concerned, leading to an enhancement in efficiency in the use of the light concerned.

In the first and second embodiments, the additional dielectric layer may be formed in the area opposite the vertical wall 15B of the partition wall 15. In this case, the additional dielectric layer constituted by a light absorption layer, and the light reflection layer formed on the back surface of the addition dielectric layer are formed in a so-called grid shape in the first embodiment.

The basic concept in the foregoing embodiments of the plasma display panel according to the present invention is that: a plurality of row electrode pairs are regularly arranged in the column direction on a back surface of a front substrate and each extend in the row direction to form a display line, one row electrode in each row electrode pair being constituted of transparent electrodes each having an end facing that of the corresponding transparent electrode of the other row electrode in the row electrode pair with a required discharge gap in between, and a bus electrode extending in the row direction and connected to the reverse end of each of the transparent electrodes from the end facing the discharge gap; a dielectric layer is formed on the back surface of the front substrate to cover the row electrode pairs; a plurality of column electrodes are regularly arranged in the row direction on a surface of a back substrate facing the front substrate with a discharge space in between, and each extend in the column direction to constitute unit light-emitting areas at intersections with the row electrode pairs in the discharge space; a light absorption layer is formed, when viewed from the surface of the front substrate, at least in part on the back surface of the front substrate in alignment with a part between two back-to-back bus electrodes of the respective row electrode pairs adjacent to each other in the row direction, and also with a part ranging from the above part to the vicinity of a side edge of the bus electrode connected to each transparent electrode; and a light reflection layer is formed on the back surface of the light absorption layer.

In the plasma display panel in the embodiments, an image to be displayed is generated by means of an opposite discharge selectively produced between the transparent electrode in each row electrode pair and the opposing column electrode, and a surface discharge produced between the transparent electrodes across the discharge gap in each row electrode pair. The light absorption layer covers the part between the two back-to-back bus electrodes which corresponds to a non-display line, and the vicinity of the bus electrode in which the light emission generated by means of the surface discharge is weak because this region is at a distance from the discharge gap across which the surface discharge is generated. With this design, when generating the image, ambient light incident from the display screen of the front substrate onto each non-display line in the image is absorbed by the light absorption layer and prevented from being reflected. Thus, the plasma display panel is capable of improving image contrast.

Further, when the image to be displayed is generated by means of the surface discharge caused between the transparent electrodes, the amount of light travelling toward the non-display line out of the light emitted within the unit light-emitting area is reflected by the light reflection layer which is formed on the back surface of the light absorption layer formed in the non-display line, to be outputted from the inside of the unit light-emitting area toward the display screen of the front substrate.

In this way, the light out of the total light generated within the unit light-emitting area, which is for forming the image but is conventionally absorbed by a light absorption layer formed in a non-display line on a panel, is reflected by the light reflection layer and allowed to contribute to the formation of the image. As a result, it is possible to improve efficiency in the use of the light emission generated within the unit light-emitting area.

The terms and description used herein are set forth by way of illustration only and are not meant as limitations. Those skilled in the art will recognize that numerous variations are possible within the spirit and scope of the invention as defined in the following claims.

What is claimed is:

1. A plasma display panel including,
a front substrate and a back substrate which are opposite to each other with a discharge space in between,
a plurality of row electrode pairs regularly arranged in the column direction on a back surface of the front substrate, and each extending in the row direction to form a display line,
a dielectric layer formed on the back surface of the front substrate to cover the row electrode pairs, and
a plurality of column electrodes regularly arranged in the row direction on a surface of the back substrate facing toward the front substrate, and each extending in the column direction to constitute unit light-emitting areas at intersections with the row electrode pairs in the discharge space,
one row electrode in each row electrode pair being constituted of transparent electrodes each having an end facing an end of the corresponding transparent electrode of the other row electrode in the row electrode pair with a required discharge gap in between, and a bus electrode extending in the row direction and connected to an reverse end of each of the transparent electrodes from the end facing the discharge gap,
said plasma display panel comprising:
a light absorption layer formed, when viewed from the surface of the front substrate, at least in part on the back surface of the front substrate in alignment with a part between the two back-to-back bus electrodes of the respective row electrode pairs adjacent to each other in the row direction, and also with a part ranging from the part to a vicinity of a side edge of the bus electrode connected to each transparent electrode; and
a light reflection layer formed on the back surface of the light absorption layer.

2. A plasma display panel according to claim 1, wherein said light absorption layer and said light reflection layer extend to a point beyond the side edge of the bus electrode connected to each transparent electrode.

3. A plasma display panel according to claim 1, further comprising:
an additional dielectric layer protruding from a position on a back surface of the dielectric layer opposite the two back-to-back bus electrodes of the respective row electrode pairs adjacent to each other in the row direction and opposite a part between the two back-to-back bus electrodes concerned,
wherein the additional dielectric layer is constituted by said light absorption layer, and said light reflection layer is formed on a back surface of the additional dielectric layer.

4. A plasma display panel according to claim 1, wherein said light absorption layer and said light reflection layer are formed in at least a position, covering a part between the two back-to-back bus electrodes of the respective row electrode pairs adjacent to each other in the row direction and also the two back-to-back bus electrodes concerned, on the back surface of the front substrate.

5. A plasma display panel according to claim 1, wherein said light absorption layer and said light reflection layer are further formed in a position extending in the column direction and opposite a boundary part between the unit light-emitting areas adjacent to each other in the row direction.
